(19) United States
(12) Patent Application Publication
(10) Pub. No.: US 2012/0266805 A1
(43) Pub. Date: Oct. 25, 2012

(54) CAUTION FLAG ASSEMBLY

(76) Inventor: Steven Schoettle, Saint Simons Island, GA (US)

(21) Appl. No.: 13/275,486

(22) Filed: Oct. 18, 2011

Related U.S. Application Data
(60) Provisional application No. 61/394,158, filed on Oct. 18, 2010.

(51) Int. Cl. G09F 17/00

(52) U.S. Cl. 116/173

(57) ABSTRACT

A caution flag assembly for hauling items comprising a body and an extending member attached to the perimeter of the body, wherein the extending member is adapted to wrap around an extended piece of equipment such that the distance between the body and an item can be easily adjusted. The body can define an aperture located adjacent the extending member. The aperture can be adapted to receive a portion of the extending member and facilitate in securing the caution flag assembly around an item, and specifically to an extended piece of equipment.

### CROSS-REFERENCE TO RELATED APPLICATION

This application claims priority under 35 U.S.C. 119(e) to U.S. Provisional Patent Application No. 61/394,158, filed Oct. 18, 2010, which is hereby incorporated by reference in its entirety as if fully set forth herein.

### BACKGROUND

1. Technical Field

Embodiments of the present invention relate to safety signaling assembly in general, and more specifically to an equipment flagging device.

2. Prior Art

Safety plays an important part in transporting heavy construction equipment and materials. In many instances, construction equipment and other large items extend beyond the boundaries of the transporting vehicle, presenting a safety hazard to surrounding vehicles and pedestrians. Consequently, many unfortunate accidents have occurred where surrounding vehicles and pedestrians have failed to observe the presence of the extending items and, consequently, collided with the corresponding transporting vehicle and/or extending item.

A common solution to this problem is to flag the equipment and materials with a warning device, such as a flag, to notify surrounding vehicles and pedestrians that a potential hazard exists. The flagging devices of the prior art, however, are inadequate because they (1) are difficult to attach to the equipment, (2) fail to fit tightly around the equipment, (3) cannot be adjusted to fit equipment of unique dimensions, and/or (4) the flagging member hangs at a distance from the equipment, as illustrated in FIG. 3.

Therefore, there is a need for an improved flagging device that cures the defects of the prior art.

### SUMMARY

Briefly described, embodiments of the present invention relate to a safety signaling assembly that can be easily and securely attached to construction equipment or materials being transported and further serves as an adequate warning that a potential hazard exists.

In some embodiments, a caution flag assembly is configured to be carried by an extended piece of construction equipment or related material, and adequately warn others of the hazard. Embodiments of the present invention provide a caution flag assembly having a body and an extending member. The extending member can be attached to the perimeter of the body such that it extends from the body. The extending member is adapted to securely wrap around an item such that the distance between the item and the body can be controlled as desired. This configuration enables the body to adequately caution others of the potential dangers associated with transporting extended pieces of construction equipment and materials. The body can define an aperture such that it is proximate the extending member. The aperture is adapted to receive a portion of the extending member and facilitate in securing the caution flag assembly around an item.

### BRIEF DESCRIPTION OF THE DRAWINGS

FIG. 1 illustrates a view of a caution flag assembly, in accordance with an exemplary embodiment of the present invention.

FIG. 2 illustrates another view of the caution flag assembly, in accordance with an exemplary embodiment of the present invention.

FIG. 3 is an illustration of the prior art attached to an extended piece of equipment.

### DETAILED DESCRIPTION

To facilitate an understanding of the principles and features of embodiments of the invention, they are explained hereinafter with reference to their implementation in an illustrative embodiment. In particular, embodiments of the invention are described in the context of being a caution flag assembly for hauling items, such as construction equipment and materials. Because of the caution flag's adjustable nature, it can be securely wrapped around various items, for example and not limited to, extended pieces of equipment or materials of various sizes and dimensions. Further, the adjustable nature of the caution flag assembly enables the flag member to remain close to the equipment or materials, therefore providing an adequate warning to other vehicles and pedestrians.

Embodiments of the invention, however, are not limited to its use as a caution flag assembly for hauling items. Rather, embodiments of the invention can also be used as a caution flag assembly for stationary items. Additionally, embodiments of the invention can be used as a flag device for athletic and/or patriotic events.

Referring now to the figures, wherein like reference numerals represent like parts throughout the views, embodiments of the present invention will be described in detail.

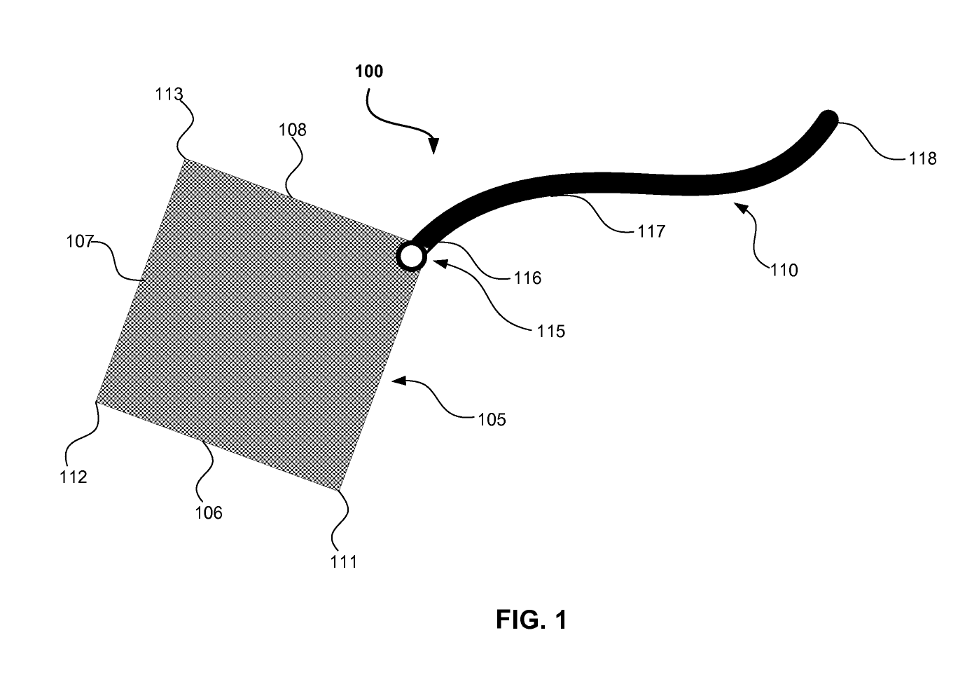

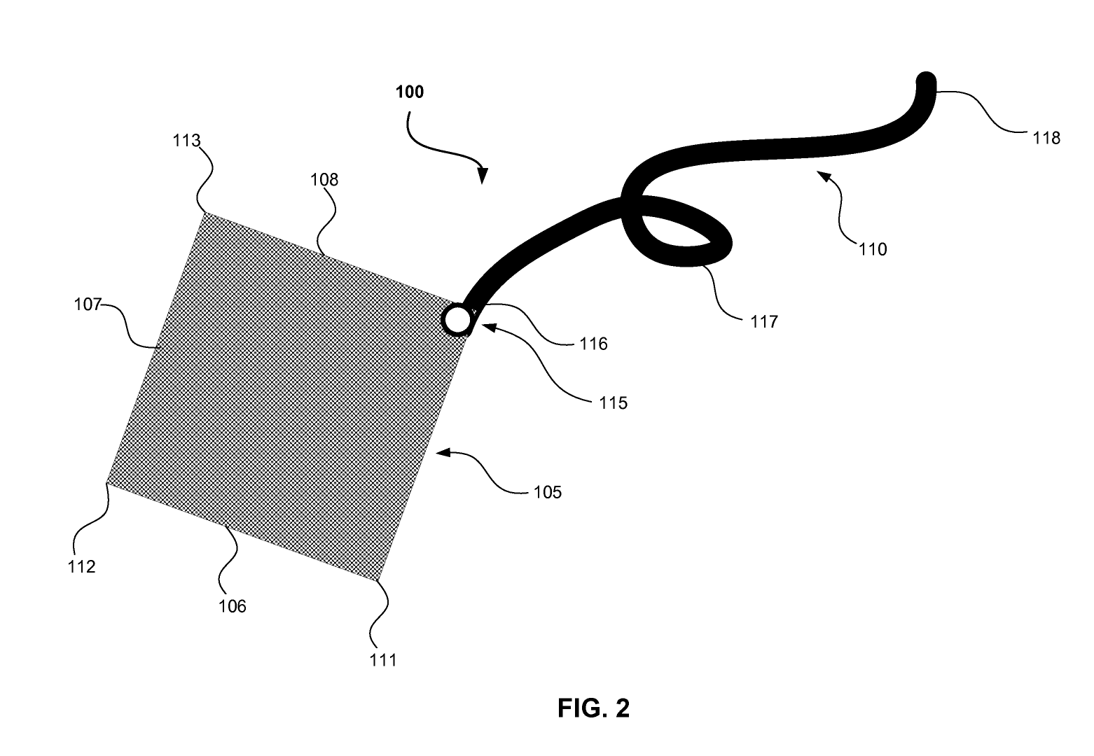

As illustrated in FIGS. 1 and 2, the caution flag assembly 100 comprises a body 105 and an extending member 110. The extending member 110 is adapted to securely wrap around an item such that the distance between the item and the body 105 can be easily adjusted.

The extending member 110 is attached to a body 105, and the body 105 can define an aperture 115 near the attachment point with the extending member 110.

The body 105 can be, for example and not limited to, a flag, a streamer, a pennant, or an emblem. The body 105 can have many shapes. FIGS. 1-2 illustrate the body 105 as being substantially square. The body 105 can also be, for example and not limited to, circular, triangular, rectangular, rhombus-like, parallelogram-like, pentagonal, hexagonal, heptagonal, octagonal, and the like. In the various embodiments, the body 105 has a circumference or a perimeter. The perimeter can have at least three sides 106, 107, 108, wherein the sides intersect to create at least three corners 111, 112, 113. As illustrated, the body 105 can have a square shape, therefore defining four sides and four corners.

The body 105 can be made of various materials, for example and not limited to, polyvinyl chlorides, coated fabrics, polyvinyls, nylons, polyesters, laminated fabrics, durable synthetic cloths, or plastics. Also, the body 105 can be made from a single piece of material or multiple pieces of material to enhance durability and add thickness. In embodiments where multiple pieces of material are used for the body 105, the pieces can be fastened together, for example, using thread, glue, staples, pins, a combination of the foregoing, or any other fastening means. The multiple pieces of material can be fastened along the perimeter of each piece. The material used for the body 105 can influence its durability and its ability to sustain in various environmental conditions, such as extreme heat or cold, rain, sleet, snow, or hail. The material also influences whether the body 105 flaps or remains sturdy in the wind.

An objective of the caution flag assembly 100 is to warn others of potential safety hazards. Thus, embodiments of the caution flag assembly 100 can include a brightly colored body 105 and/or include a warning symbol. Also, the size of the body 105 can be increased as this would cause the flag assembly 100 to be more visible to others. In one example, the body 105 can be approximately 15½ inches by 15½ inches in dimension. The body 105 is not, however, limited to these dimensions and the dimensions can change in accordance with a specific application.

An extending member 110 can be attached to the body 105. The extending member 110 can be, for example and not limited to, an elongated cord, an adjustable cord, an elongated tie, or other variations thereof. The extending member 110 has a first end 116, a middle section 117, and a second end 118. The first end 116 of the extending member 110 is attached to the body 105. In exemplary embodiments, the first end 116 is attached to the perimeter of the body 105 such that the extending member 110 extends from the perimeter of the body 105. In embodiments where the perimeter is comprised of sides and corners, the first end 116 can be attached to a side or corner of the body 105. Irrespective of where the first end 116 is attached, it can be attached such that the extending member 110 extends from the perimeter of the body 105. The first end 116 of the extending member 110 can be attached to the body 105 using, for example and not limitation, thread, stitching, glue, staples, pins, a combination of the foregoing, or other fastening means.

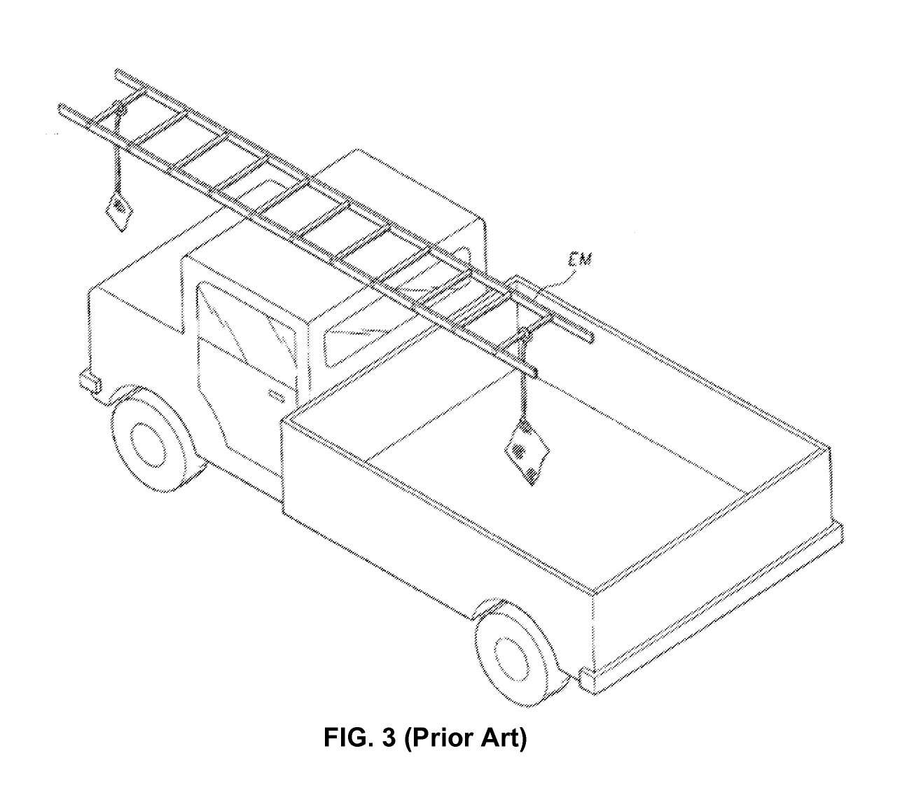

A common problem associated with the prior art, as illustrated in FIG. 3, is that the flag component of the device hangs at a distance from the equipment and therefore fails to sufficiently warn vehicles and pedestrians of the potential hazard. The embodiments of the present invention cure the defects of the prior art because the extending member 110 comprises materials that enable the extending member 110 to securely wrap around an item such that the distance between the item and the body 105 can be adjusted. The extending member 110 can be made from various materials. The material can be flexible and can have a hook and loop fastening means on opposing sides of the extending member. Additionally, the extending member 110 can be compatible with a supplemental hook and loop fastening means. For example, the extending member 110 can be made from VELCRO®. VELCRO® has flexible characteristics enabling the middle section 117 of the extending member 110 to bend and fold, therefore enabling the extending member 110 to wrap around an item. Additionally, the hook and loop fastening characteristics of VELCRO® enable the extending member 110 to wrap securely around an item.

The length and width of the extending member 110 can vary depending on the application. In one example, the length of the extending member 110 can be approximately 32 inches long and the width can be approximately ½-¾ inches. The length and width of the extending member 110 can be increased for large, thick items and decreased for small, thin items.

The body 105 can define at least one aperture. The aperture 115 can also be, for example and not limited to, a gap, a space, a puncture, a slit, a slot, or other similar variations. In the various embodiments of the present invention, the aperture 115 can be substantially near the perimeter of the body 105, such that it is near the first end 116 of the extending member 110. Further, the aperture 115 can be adapted to receive the second end 118 of the extending member 110, wherein the second end 118 can weave through and further secure the wrapping of the extending member 110 around an item. The aperture 115 can be of many shapes, for example and not limited to, a circle, a square, or an oval. The aperture 115 can be further supported with a metal, rubber, or plastic ring, such as a grommet.

From the foregoing, it can be seen that the present invention provides a caution flag assembly, wherein the adjustable nature of the extending member 110 enables the body 105 to remain close to an item and provide an adequate warning to surrounding vehicles and pedestrians.

Embodiments of the present invention can be embodied in other specific forms without departing from the spirit or essential characteristics thereof. Additionally, the specific configurations, choice of materials, and the size and shape of the various elements can be varied according to particular design specifications or constraints of the construction equipment or materials being hauled. Such changes are intended to be embraced within the scope of the invention.

The presently disclosed embodiments are, therefore, considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A caution flag assembly, comprising:
a body having a perimeter; and
a flexible extending member having a first end and a second end, wherein the first end is attached to the perimeter of the body;
wherein the extending member is adapted to securely wrap around an item such that a distance between the item and the body is adjustable.

2. The caution flag assembly of claim 1, wherein the perimeter of the body has at least three sides.

3. The caution flag assembly of claim 1, wherein the body is substantially square.

4. The caution flag assembly of claim 1, wherein the body is made of coated fabrics, polyvinyls, nylons, polyesters, laminated fabrics, durable synthetic cloths, plastics, or a combination thereof.

5. The caution flag assembly of claim 1, wherein the body comprises at least one piece of material.

6. The caution flag assembly of claim 1, wherein the body is about 15½ inches by about 15½ inches in dimension.

7. The caution flag assembly of claim 1, wherein the extending member is an elongated cord.

8. The caution flag assembly of claim 1, wherein the first end of the extending member is attached to the perimeter of the body via thread, stitching, glue, staples, pins, or a combination thereof.

9. The caution flag assembly of claim 1, wherein the extending member comprises a hook and loop fastening means.

10. The caution flag assembly of claim 1, wherein the extending member is about 32 inches in length.

11. The caution flag assembly of claim 1, wherein the extending member is about ½ to about ¾ inches in width.

12. The caution flag assembly of claim 1, further comprising an aperture defined within the body.

13. The caution flag assembly of claim 12, wherein the aperture is proximate the first end of the extending member.

14. The caution flag assembly of claim 12, wherein the aperture is configured to receive the second end of the extending member.

15. The caution flag assembly of claim 12, wherein the aperture is further supported by a metal ring, a rubber ring, a plastic ring, or a combination thereof.

16. A caution flag assembly, comprising:
a body having a perimeter, wherein the perimeter of the body has at least three sides;
a flexible extending member having a first end and a second end, wherein the first end is attached to the perimeter of the body, and further wherein the extending member is adapted to securely wrap around an item such that a distance between the item and the body is adjustable; and
an aperture defined within the body, wherein the aperture is proximate the first end of the extending member and configured to receive the second end of the extending member.
